(19) United States
(12) Patent Application Publication
(10) Pub. No.: US 2026/0265506 A1
(43) Pub. Date: Sep. 10, 2026

(54) RUBBER COMPOSITION COMPRISING A BIO-BASED PLASTICIZER

(71) Applicant: COMPAGNIE GENERALE DES ETABLISSEMENTS MICHELIN, Clermont-Ferrand (FR)

(72) Inventors: ARNAUD RODRIGUES, Clermont-Ferrand (FR); ANGELIQUE PAWLAK, Clermont-Ferrand (FR); SALVATORE PAGANO, Clermont-Ferrand (FR)

(21) Appl. No.: 18/876,723

(22) PCT Filed: Jun. 29, 2023
(86) PCT No.: PCT/EP2023/067792

§ 371 Date: Dec. 19, 2024

(30) Foreign Application Priority Data
Jun. 30, 2022 (FR) 2206655

(51) Int. Cl. C08L 9/00; B60C 1/00; C08K 5/101; C08K 5/103

(52) U.S. Cl. CPC C08L 9/00; B60C 1/0025; C08K 5/101; C08K 5/103; C08L 2205/03; C08L 2205/06; C08L 2312/00

(57) ABSTRACT

A rubber composition is based on at least: 100 phr of an elastomer matrix comprising an isoprene elastomer and a butadiene elastomer, 20 to 120 phr of a reinforcing filler comprising carbon black as predominant filler, 5 to 120 phr of a plasticizing system comprising, as biobased plasticizer, an ester of a fatty acid and an alcohol selected from fatty alcohols and diol dimers, with a weight-average molar mass (Mw) of less than 5000 g/mol determined by size exclusion chromatography (SEC), and a crosslinking system.

### TECHNICAL FIELD

The present invention relates to a tyre rubber composition, in particular which can be used in a sidewall, comprising a plasticizing system which is wholly or partially biobased.

### PRIOR ART

In the current context of saving energy and preserving the environment, manufacturers are constantly looking for new renewable sources that can be used as raw materials for the manufacture of products.

For this purpose, tyre manufacturers are seeking to reduce the environmental impact of the manufacture of tyres and their use. Among the levers at their disposal is the gradual replacement of fossil-derived materials with sustainable materials. Materials of biobased origin constitute a portion of these sustainable materials. However, the replacement of petroleum-derived products in the compositions constituting the tyre with products of biobased origin must not be carried out to the detriment of the expected safety and performance qualities. Thus, the products of biobased origin used in the tyre must be compatible with the other constituents of the rubber composition containing them in order to ensure uniformity of the composition so as not to degrade the compromises of properties, and to perform technically as well as products prepared from raw materials of fossil origin.

Among the constituent elements of the tyre, the outer sidewalls must in particular have good resistance to external attacks such as impacts and deformations. The outer sidewalls are the radially outer regions of the tyre, which connect the crown of the tyre to the two beads. It is therefore important for the rubber compositions constituting the sidewalls of the tyres to have good mechanical properties, in particular good properties at break.

The technical problem that now arises is that of providing a rubber composition for a tyre that contributes to reducing its environmental footprint while maintaining its performance properties, particularly for use in a sidewall. More particularly, one objective of the present invention is to reduce the environmental footprint of a tyre rubber composition while maintaining the mechanical properties of the composition.

### DISCLOSURE OF THE INVENTION

The applicant has discovered, surprisingly, that replacing petroleum-derived plasticizers in tyre rubber compositions with esters of a fatty acid with an alcohol selected from fatty alcohols and diol dimers makes it possible to improve allows a significant improvement in the limiting properties at break, the stiffness at low strain remaining unchanged. Such properties are particularly valuable for use in the sidewall of a tyre.

### SUMMARY OF THE INVENTION

The invention therefore relates to a rubber composition based on at least one elastomer matrix comprising an isoprene elastomer and a butadiene elastomer, a reinforcing filler comprising carbon black as predominant filler, a crosslinking system and a plasticizing system comprising a biobased plasticizer selected from esters of a fatty acid and an alcohol selected from fatty alcohols and diol dimers, according to one of the following embodiments.
1. Rubber composition based on at least:
   −100 phr of an elastomer matrix comprising an isoprene elastomer and a butadiene elastomer,
   20 to 120 phr of a reinforcing filler comprising carbon black as predominant filler,
   5 to 120 phr of a plasticizing system comprising an ester of a fatty acid and an alcohol selected from fatty alcohols and diol dimers, with a weight-average molar mass (Mw) of less than 5000 g/mol determined by size exclusion chromatography (SEC), the method being described in the description,
   a crosslinking system.
2. Composition according to the preceding embodiment, in which the content of isoprene elastomer is within a range extending from 10 to 60 phr, preferably from 15 to 50 phr.
3. Composition according to either one of the preceding embodiments, in which the isoprene elastomer predominantly comprises natural rubber.
4. Composition according to any one of the preceding embodiments, in which the content of butadiene elastomer is within a range extending from 40 to 90 phr, preferably from 50 to 85 phr.
5. Composition according to any one of the preceding embodiments, in which the butadiene elastomer is a polybutadiene.
6. Composition according to any one of the preceding embodiments, in which the reinforcing filler consists essentially of carbon black.
7. Composition according to any one of the preceding embodiments, in which the carbon black is present at a content within a range extending from 20 phr to 100 phr, preferably ranging from 20 to 80 phr, more preferentially ranging from 25 to 60 phr.
8. Composition according to any one of the preceding embodiments, in which the content of ester of a fatty acid with an alcohol selected from fatty alcohols and diol dimers is within a range extending from 5 to 50 phr, preferably from 10 to 30 phr.
9. Composition according to any one of the preceding embodiments, in which the plasticizing system comprises from 10% to 100% by weight of at least one ester of a fatty acid and an alcohol selected from fatty alcohols and diol dimers, preferably 40% to 100% by weight, relative to the total weight of the plasticizing system.
10. Composition according to any one of the preceding embodiments, in which the plasticizing system consists essentially of at least one ester of a fatty acid and an alcohol selected from fatty alcohols and diol dimers.
11. Composition according to any one of the preceding embodiments, in which the fatty acid is a C₈ to C₃₄, notably C₁₂ to C₂₂ and more particularly C₂₂ fatty acid.
12. Composition according to the preceding embodiment, in which the fatty acid is erucic acid.
13. Composition according to any one of the preceding embodiments, in which the alcohol is a linear or branched, saturated or unsaturated C₈ to C₃₄, notably C₈ to C₂₆, notably C₁₂ to C₂₂ in particular C₁₆ to C₂₀ and more particularly C₁₈ fatty alcohol.
14. Composition according to the preceding embodiment, in which the alcohol is isostearyl alcohol.
15. Composition according to any one of the preceding embodiments, in which the alcohol is a diol dimer obtained by dimerizing at least one C₈ to C₃₄, notably C₁₂ to C₂₂, in particular C₁₆ to C₂₀, and more particularly C₁₈ fatty acid, followed by a hydrogenation of the carboxylic acid functions.
16. Composition according to any one of the preceding embodiments, in which the alcohol is a saturated or unsaturated, cyclic or acyclic aliphatic C₃₆ diol dimer.
17. Composition according to any one of the preceding embodiments, in which the alcohol is a preferably saturated, alicyclic C₃₆ diol dimer.
18. Composition according to any one of the preceding embodiments, in which the at least one ester of a fatty acid and an alcohol is the ester of erucic acid and isostearyl alcohol.
19. Composition according to any one of the preceding embodiments, in which the at least one ester of a fatty acid and an alcohol is an ester of erucic acid and a preferably saturated, alicyclic C₃₆ diol dimer.

The invention also relates to a tyre, one of the constituent elements of which comprises a rubber composition according to any one of the preceding embodiments. More particularly, the invention then relates to a tyre having an outer sidewall, said outer sidewall comprising at least one rubber composition according to any one of the preceding embodiments.

### Definitions

The expression “part by weight per hundred parts by weight of elastomer” (or phr) should be understood as meaning, within the meaning of the present invention, the part by weight per hundred parts by weight of elastomer or rubber.

In the present document, unless expressly indicated otherwise, all the percentages (%) indicated are percentages (%) by weight.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

In the present document, the expression composition “based on” is intended to mean a composition comprising the mixture and/or the reaction product of the various constituents used, some of these base constituents being capable of reacting or intended to react with one another, at least in part, during the various phases of manufacture of the composition, in particular during the crosslinking or vulcanization thereof. By way of example, a composition based on an elastomer matrix and on sulfur comprises the elastomer matrix and the sulfur before curing, whereas, after curing, the sulfur is no longer detectable as the latter has reacted with the elastomer matrix with the formation of sulfur (polysulfide, disulfide, monosulfide) bridges.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Preferentially, this is the compound which represents, for example, more than 50%, 60%, 70%, 80%, 90%, or even 100% by weight relative to the total weight of the type of compound. Thus, for example, a predominant reinforcing filler is the reinforcing filler representing the greatest weight relative to the total weight of the reinforcing fillers in the composition. In contrast, a “minor” compound is a compound which does not represent the greatest fraction by weight among the compounds of the same type.

The compounds mentioned in the description may be of fossil origin or may be biobased. In the latter case, they may be partially or completely derived from biomass or obtained from renewable raw materials derived from biomass. In the same way, the compounds mentioned can also originate from the recycling of pre-used materials, that is to say that they can, partially or completely, result from a recycling process, or else be obtained from starting materials which themselves result from a recycling process. This notably concerns polymers, plasticizers, fillers, etc.

### DETAILED DESCRIPTION OF THE INVENTION

1 Elastomer matrix

The rubber composition according to the invention comprises an elastomer matrix comprising an isoprene elastomer and a butadiene elastomer.

Isoprene elastomer and butadiene elastomer that are capable of being used in the compositions in accordance with the invention is intended more particularly to mean:
(a) any homopolymer obtained by polymerization of an isoprene monomer, or respectively of a butadiene monomer;
(b) any copolymer obtained by copolymerization of an isoprene monomer, or respectively of a butadiene monomer, with one or more other monomers. Mention may be made, as other monomer, of ethylene, an olefin and a conjugated or non-conjugated diene other than isoprene, or respectively butadiene.

The term “isoprene elastomer” or “polyisoprene” is intended to mean, in a known way, an isoprene homopolymer or copolymer, in other words a diene elastomer selected from the group consisting of natural rubber (NR), which can be plasticized or peptized, synthetic polyisoprenes (IR), the various isoprene copolymers and the mixtures of these elastomers. Mention will in particular be made, among isoprene copolymers, of isobutene/isoprene (butyl rubber IIR), isoprene/styrene (SIR), isoprene/butadiene (BIR) or isoprene/butadiene/styrene (SBIR) copolymers. Preferably, the polyisoprene is selected from the group consisting of natural rubber, a synthetic polyisoprene and a mixture thereof, more preferably the polyisoprene predominantly, or even exclusively, comprises natural rubber.

Preferably, the polyisoprene comprises a content by weight of cis-1,4 bonds of at least 90%, more preferentially of at least 98%, with respect to the weight of the polyisoprene.

Preferentially, the content of polyisoprene, preferably natural rubber, is from 10 to 60 phr, more preferentially from 15 to 50 phr, even more preferentially from 20 to 50 phr and very preferentially from 25 to 45 phr.

The term “butadiene elastomer” is intended to mean, in a known way, a butadiene homopolymer or copolymer, in other words a diene elastomer selected from the group consisting of polybutadienes (BR), butadiene copolymers such as butadiene-styrene copolymers (SBR), isoprene-butadiene copolymers (BIR), isoprene-butadiene-styrene copolymers (SBIR), butadiene-acrylonitrile copolymers (NBR), butadiene-styrene-acrylonitrile copolymers (NSBR) or a mixture of two or more of these compounds.

Preferably, the butadiene elastomer is selected from the group consisting of polybutadienes (BR) and the mixtures thereof.

Preferably, the polybutadiene (BR) comprises a weight content of cis-1,4 bonds of at least 90% relative to the weight of the polybutadiene.

Preferentially, the content of butadiene elastomer is from 40 to 90 phr, more preferentially from 50 to 85 phr, even more preferentially from 50 to 80 phr and very preferentially from 55 to 75 phr.

The isoprene elastomer is different from the butadiene elastomer.

The elastomer matrix of the rubber composition according to the invention may comprise one or more other diene elastomers other than the butadiene elastomer and the isoprene elastomer.

The diene elastomer(s) may be selected, for example, from the group consisting of natural rubber (NR), synthetic polyisoprenes (IR), polybutadienes (BR), butadiene copolymers, isoprene copolymers and the mixtures of these elastomers. Such copolymers are more preferentially selected from the group consisting of butadiene-styrene copolymers (SBR), isoprene-butadiene copolymers (BIR), isoprene-styrene copolymers (SIR), isoprene-butadiene-styrene copolymers (SBIR), butadiene-acrylonitrile copolymers (NBR), butadiene-styrene-acrylonitrile copolymers (NSBR), ethylene-butadiene copolymers (EBR) and terpolymers of ethylene, butadiene and another conjugated diene monomer, notably isoprene, myrcene or farnesene, or a mixture of two or more of these compounds.

Preferably, the elastomer matrix of the rubber composition according to the invention predominantly comprises a mixture of an isoprene elastomer, preferably natural rubber, and a butadiene elastomer, preferably a polybutadiene. More preferably, the elastomer matrix of the rubber composition according to the invention consists essentially of a mixture of an isoprene elastomer, preferably natural rubber, and a butadiene elastomer, preferably a polybutadiene.

2 Reinforcing filler

The rubber composition in accordance with the invention also has the essential characteristic of comprising a reinforcing filler comprising carbon black as predominant filler.

All carbon blacks, notably the blacks conventionally used in tyres or their treads, are suitable as carbon blacks. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated into the diene elastomer, notably isoprene elastomer, in the form of a masterbatch (see, for example, patent applications WO 97/36724-A2 and WO 99/16600-A1).

The reinforcing filler can comprise another reinforcing filler. For this purpose, use may be made of any type of “reinforcing” filler other than carbon black, known for its abilities to reinforce a rubber composition which can be used in particular in the manufacture of tyres, for example an inorganic filler such as silica.

Mineral fillers of the siliceous type, preferentially silica (SiO₂), or of the aluminous type, especially alumina (Al₂O₃), are suitable in particular as reinforcing inorganic fillers. The silica used can be any reinforcing silica known to a person skilled in the art, in particular any precipitated or fumed silica having a BET specific surface area and a CTAB specific surface area both of less than 450 m²/g, preferably within a range extending from 30 to 400 m²/g, in particular from 60 to 300 m²/g.

Use may be made of any type of precipitated silica, in particular highly dispersible precipitated silicas (HDS, for “highly dispersible silicas”). These precipitated silicas, which may or may not be highly dispersible, are well known to those skilled in the art. Mention may be made, for example, of the silicas described in patent applications WO 03/016215-A1 and WO 03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

Mention may again be made, as other examples of inorganic fillers capable of being used in the rubber compositions of the invention, of mineral fillers of the aluminous type, in particular alumina (Al₂O₃), aluminium oxides, aluminium hydroxides, aluminosilicates, titanium oxides, silicon carbides or silicon nitrides, all of the reinforcing type as described, for example, in patent applications WO 99/28376-A2, WO 00/73372-A1, WO 02/053634-A1, WO2004/003067-A1, WO2004/056915-A2, U.S. Pat. No. 6,610,261-B1 and U.S. Pat. No. 6,747,087-B2. Mention may in particular be made of the aluminas Baikalox A125 or CR125 (Baïkowski), APA-100RDX (Condéa), Aluminoxid C (Evonik) or AKP-G015 (Sumitomo Chemicals).

The physical state in which the reinforcing inorganic filler is provided is not important, whether it is in the form of a powder, of micropearls, of granules or else of beads or any other appropriate densified form. Of course, “reinforcing inorganic filler” is also understood to mean mixtures of different reinforcing inorganic fillers, in particular of silicas as described above.

A person skilled in the art will understand that, as a replacement for the reinforcing inorganic filler described above, a reinforcing filler of another nature may be used, provided that this reinforcing filler of another nature is covered with an inorganic layer such as silica, or includes on its surface functional sites, notably hydroxyl sites, requiring the use of a coupling agent to establish the bond between this reinforcing filler and the diene elastomer. Mention may be made, by way of example, of carbon blacks partially or completely covered with silica, or of carbon blacks modified by silica, such as, without limitation, the fillers of Ecoblack® type of the CRX2000 series or of the CRX4000 series from Cabot Corporation.

The reinforcing filler predominantly comprises carbon black. Preferably, for the invention, the reinforcing filler consists essentially of carbon black.

Preferably, the content of carbon black is within a range extending from 20 phr to 100 phr, preferably ranging from 20 to 80 phr, more preferentially ranging from 25 to 60 phr.

A person skilled in the art will know how to adjust the total content of reinforcing filler according to the use in question in the range from 20 to 120 phr as a function of the intended use of the rubber composition. Thus, according to certain alternative embodiments of the invention, the total content of reinforcing filler is from 30 to 80 phr, preferentially from 35 to 70 phr.

In the present disclosure, the BET specific surface area is determined by gas adsorption using the Brunauer-Emmett-Teller method described in “The Journal of the American Chemical Society”, (vol. 60, page 309, February 1938), and more specifically according to a method derived from standard NF ISO 5794-1, Appendix E, of June 2010 [multipoint (5 point) volumetric method-gas:nitrogen-degassing under vacuum:one hour at 160° C.-relative pressure p/po range: 0.05 to 0.17].

For the inorganic fillers, such as silica for example, the CTAB specific surface area values were determined according to standard NF ISO 5794-1, Appendix G, of June 2010. The process is based on the adsorption of CTAB (N-hexadecyl-N,N,N-trimethylammonium bromide) on the “outer” surface of the reinforcing filler.

In order to couple the reinforcing inorganic filler to the diene elastomer, use may be made, in a well-known way, of an at least bifunctional coupling agent (or bonding agent) intended to provide a satisfactory interaction, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (which may be symmetrical or asymmetrical), such as

bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, or blocked mercaptosilanes, such as S-(3-(triethoxysilyl) propyl) octanethioate sold by Momentive under the name NXT Silane. More preferentially, the organosilane is an organosilane polysulfide.

Of course, use might also be made of mixtures of the coupling agents described above.

The content of coupling agent in the composition of the invention is advantageously less than or equal to 30 phr, it being understood that it is generally desirable to use as little as possible thereof. Typically, the content of coupling agent represents from 0.5% to 15% by weight, with respect to the amount of reinforcing inorganic filler. This content is easily adjusted by those skilled in the art according to the content of reinforcing inorganic filler used in the composition of the invention.

### 3 Plasticizing System

The rubber composition according to the invention comprises from 5 to 120 phr of a plasticizing system and preferentially from 10 to 80 phr.

The plasticizing system of a tyre rubber composition may comprise one or more plasticizers.

According to the invention, the plasticizing system comprises at least one ester of a fatty acid and an alcohol selected from fatty alcohols and diol dimers, as biobased plasticizer. The weight-average molar mass (Mw) of the ester in accordance with the invention is less than 5000 g/mol and preferably within a range varying from 700 to 5000 g/mol, more preferably within a range varying from 700 to 3500 g/mol. The weight-average molar mass (Mw) of the ester is measured by SEC (size exclusion chromatography) according to the method described below.

### Fatty Acid Esters

Esters of fatty acids and alcohols selected from fatty alcohols and diol dimers are a class of esters which can be 100% biobased when the fatty acids and alcohols are of natural origin.

According to embodiments of the invention, the plasticizing system comprises from 10% to 100% by weight of at least one ester of a fatty acid with an alcohol selected from fatty alcohols and diol dimers, preferably 40% to 100% by weight, relative to the total weight of the plasticizing system. According to particular embodiments of the invention, the plasticizing system comprises 100% by weight of at least one ester of a fatty acid with an alcohol selected from fatty alcohols and diol dimers, that is to say that the plasticizing system consists essentially of at least one ester of a fatty acid with an alcohol selected from fatty alcohols and diol dimers.

According to the invention, the rubber composition preferably comprises from 5 to 50 phr, more preferentially from 10 to 30 phr of at least one ester of a fatty acid and an alcohol selected from fatty alcohols and diol dimers.

According to embodiments of the invention, the ester of a fatty acid and of an alcohol selected from fatty alcohols and diol dimers is a compound obtained from a linear or branched, saturated or unsaturated, C₈ to C₃₄, notably C₁₂ to C₃₀, notably C₁₂ to C₂₂, and more particularly C₂₂ fatty acid.

According to the invention, the expression “branched fatty acid” means a fatty acid having a methyl group attached to the penultimate or antepenultimate carbon atom or several methyl groups distributed along the chain.

The reader will understand that, in order to reduce the environmental impact of the rubber composition according to the invention, a fatty acid is very preferentially understood to mean a fatty acid of natural origin, obtained by hydrolysis of vegetable oils, such as, to mention but a few examples, the fatty acids of: orange oil, avocado oil, macadamia oil, olive oil, hydrogenated soybean oil, rapeseed oil, jojoba oil, palm oil, castor oil, wheat germ oil, saffron oil, linseed oil, safflower oil, maize oil, pine oil, sunflower oil, coconut oil, peanut oil, grape seed oil, cottonseed oil, macadamia oil and mixtures thereof.

Among the fatty acids of natural origin, examples that may be mentioned include:
-saturated linear fatty acids such as caprylic acid, capric acid, lauric acid, myristic acid, palmitic acid, stearic acid, arachidic acid, behenic acid, lignoceric acid, cerotic acid,
saturated or unsaturated, branched fatty acids, such as for example isostearic acid, isopalmitic acid,
unsaturated, linear fatty acids, such as linderic acid, myristoleic acid, palmitoleic acid, oleic acid, linoleic acid, elaidic acid, gadoleic acid, eicosapentaenoic acid, docosahexaenoic acid, erucic acid, brassidic acid, arachidonic acid,
hydroxy fatty acids such as ricinoleic acid, hydroxystearic acids.

More particularly, according to embodiments of the invention, the fatty acid is erucic acid. The erucic acid can in particular be extracted from erucic rapeseed oil.

The ester obtained may be a diester, a monoester or a mixture thereof. To be precise, the ester may be a mixture of two or more types of esters formed with different fatty acids and/or different alcohols.

According to embodiments of the invention, the at least one ester of a fatty acid and an alcohol is an ester of a fatty acid and a fatty alcohol.

Esters of fatty acids and fatty alcohols, or long-chain alcohols, are compounds used in a known manner, in particular as constituents of the fatty phases in cosmetic compositions such as lotions, ointments, creams and makeup.

For the purposes of the present invention, the expression “fatty alcohol” is intended more particularly to denote an alcohol obtained by catalytic hydrogenation of a linear or branched, saturated or unsaturated C₈ to C₃₄, notably C₈ to C₂₆, notably C₁₂ to C₂₂, in particular C₁₆ to C₂₀ and more particularly C₁₈ fatty acid. Very preferentially, the fatty acid from which the fatty alcohol is derived is of natural origin as described above.

The fatty alcohol may be a saturated or unsaturated linear C₈ to C₃₄ fatty alcohol, preferably a linear C₈ to C₂₆, notably C₁₂ to C₂₂ and more particularly C₁₈ fatty alcohol, like stearyl alcohol, oleyl alcohol and linoleyl alcohol, for example.

The fatty alcohol may be a branched fatty alcohol. According to the invention, the expression “branched fatty alcohol” is intended to denote an alcohol derived from a fatty acid having a methyl group attached to the penultimate or antepenultimate carbon atom or several methyl groups distributed along the chain. These branched fatty alcohols are preferably C₈ to C₂₆, notably C₁₂ to C₂₂ and more particularly C₁₈ fatty alcohols, like isostearyl alcohol.

According to a particular embodiment of the invention, the fatty alcohol is preferably isostearyl alcohol.

According to other embodiments of the invention, the at least one ester of a fatty acid with an alcohol is an ester of a fatty acid with a diol dimer. Such compounds are known and described in applications in the field of cosmetics. Mention may thus be made of EP1604638A2 or EP1683513A1 describing esters of diol dimers and of fatty acids used to help to impart gloss and wear property to cosmetic compositions containing them.

For the purposes of the present invention, the term “diol dimer” is understood to mean more particularly the diol produced by catalytic hydrogenation of the acid functions of a dicarboxylic acid dimer, itself obtained by dimerization of a preferably unsaturated, notably C₈ to C₃₄, notably C₁₂ to C₂₂, in particular C₁₆ to C₂₀, and more particularly C₁₈ fatty acid, such as, for example, oleic acid and linoleic acid. Very preferentially, the fatty acid from which the fatty alcohol is derived is of natural origin as described above. The diol dimers that can be used in the context of the invention may be hydrogenated or non-hydrogenated. They can be synthesized in a conventional manner from dimerized fatty acids. Dimerized fatty acids are commercially available, for example under the name Pripol (Pripol 1013, Pripol 1009, Pripol 1017, etc.) from Croda.

The diol dimers that can be used in the context of the invention are also available commercially. Examples that may be mentioned include the C₃₆ diol dimers sold under the name Pripol 2033, Pripol 2043 and Pripol 2013 by Croda.

According to embodiments of the invention, the diol dimer derived from a dimerized fatty acid is aliphatic, cyclic or acyclic, and saturated or unsaturated. The term “cyclic” means a monocyclic or polycyclic diol dimer, i.e. one comprising one or more aliphatic rings in its structure. According to particular embodiments of the invention, the diol dimer is a saturated or unsaturated, alicyclic (aliphatic and cyclic), preferably C₃₆ diol dimer. An example of such a diol dimer is Pripol 2033 from Croda.

According to particular embodiments of the invention, the specific fatty acid ester useful in the invention is a diester of a C₁₈ or C₂₂ fatty acid, preferentially respectively a diester of ricinoleic acid or a diester of erucic acid, which has undergone esterification with a diol dimer, preferentially a saturated or unsaturated, alicyclic C₃₆ diol dimer, preferentially which is saturated, for instance Pripol 2033 from Croda.

According to particular embodiments of the invention, the ester of a fatty acid and an alcohol is preferably a compound obtained from a C₂₂ fatty acid, preferentially erucic acid, which has undergone esterification with an alcohol such as a branched C₁₂ to C₂₂ and more particularly C₁₈ fatty alcohol, preferentially isostearyl alcohol, or with an alicyclic C₃₆ diol dimer, preferably which is saturated. Preferentially, according to these embodiments, the ester of a fatty acid and an alcohol is the ester of erucic acid and isostearyl alcohol or the ester of erucic acid and a saturated, alicyclic C₃₆ diol dimer.

Advantageously, the erucic acid of this ester is obtained from erucic rapeseed oil.

### Other Plasticizers

According to embodiments of the invention, the plasticizer system consists essentially of at least one ester of a fatty acid with an alcohol selected from fatty alcohols and diol dimers.

Thus, according to other embodiments of the invention, the plasticizing system may comprise one or more other plasticizing compounds customarily used in tyre rubber compositions. These other plasticizing compounds may be selected from plasticizing hydrocarbon resins and plasticizers that are liquid at ambient temperature (around 23° C.).

Any extender oil, whether of aromatic or non-aromatic nature, or any liquid plasticizing agent known for its plasticizing properties with regard to diene elastomers may be used in addition to the fatty acid ester as liquid plasticizer. As examples of liquid plasticizers that can be used in the context of the invention, mention may be made of those selected from liquid diene polymers, polyolefin oils, naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulfonate plasticizers and mixtures of these compounds.

The reader will understand that, in order to reduce the environmental impact of the rubber composition according to the invention, if at least one other plasticizer is used in the rubber composition, the latter will preferably be of a renewable nature, in particular of biobased origin.

### 4 Crosslinking System

The crosslinking system may be any type of system known to those skilled in the art in the field of rubber compositions for tyres. It can in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used at a preferential content of between 0.2 phr and 10 phr. The primary vulcanization accelerator is used at a preferential content of between 0.5 and 10 phr, more preferentially of between 0.5 and 5 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### 5 Possible Additives

The rubber compositions according to the invention can optionally also comprise all or part of the usual additives generally used in tyre elastomer compositions, such as, for example, pigments, protective agents such as antiozone waxes, chemical antiozonants, antioxidants other than the phenolic antioxidant of general formula (I), anti-fatigue agents, promoters of adhesion to metal reinforcements, in particular based on cobalt salts (such as cobalt acetylacetonate, cobalt resinate, cobalt 2-ethylhexanoate or else cobalt hydroxide), or also reinforcing resins (such as described, for example, in patent application WO 02/10269).

### 6 Preparation of the Rubber Compositions

The compositions in accordance with the invention may be manufactured in appropriate mixers using two successive preparation phases that are well known to those skilled in the art:
a first phase of thermomechanical working or kneading (known as the “non-productive” phase), that can be performed in one or more thermomechanical steps during which all the necessary constituents, notably the elastomer matrix, the reinforcing filler, the ester of a fatty acid with an alcohol selected from fatty alcohols and diol dimers and the various other optional additives, with the exception of the crosslinking system, are introduced into an appropriate mixer, such as a standard internal mixer (for example of Banbury type). The incorporation of the optional filler into the elastomer may be performed in one or more portions while thermomechanically kneading. In the case where the filler is already incorporated, in full or in part, into the elastomer in the form of a masterbatch, as is described, for example, in patent applications WO 97/36724 and WO 99/16600, it is the masterbatch which is directly kneaded and, if appropriate, the other elastomers or fillers present in the composition which are not in the masterbatch form, and also the ester of a fatty acid with an alcohol selected from fatty alcohols and diol dimers and the various other optional additives, with the exception of the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

The final composition thus obtained is then calendered, for example in the form of a sheet or of a slab, notably for laboratory characterization, or else is extruded (or co-extruded with another rubber composition) in the form of a rubber semi-finished product (or profiled element) that may be used, for example, as a tyre sidewall. These products may then be used for the manufacture of tyres, according to the techniques known to those skilled in the art.

The composition may be either in the uncured state (before crosslinking or vulcanization) or in the cured state (after crosslinking or vulcanization), or may be a semi-finished product which can be used in a tyre.

The crosslinking (or curing), if appropriate the vulcanization, is carried out in a known way at a temperature generally of between 130° C. and 200° C., for a sufficient time which can vary, for example, between 5 and 90 min as a function in particular of the curing temperature, of the crosslinking system adopted and of the kinetics of crosslinking of the composition under consideration.

### 7 Tyre

The invention also relates to a tyre comprising, in one of its components, a rubber composition as described above.

It is possible to define, within the tyre, three types of regions:
The radially exterior region in contact with the ambient air, this region consisting essentially of the tread and of the outer sidewall of the tyre.
The radially interior region in contact with the inflation gas, this region consisting generally of the layer airtight to the inflation gases, sometimes referred to as inner liner.
The internal region of the tyre, that is to say the region between the exterior and interior regions. This region includes layers or plies which are referred to here as internal layers of the tyre.

More particularly, in view of the significant improvement in the properties at break of the rubber composition according to the invention compared with a composition comprising a conventional plasticizing system of fossil origin, the rubber composition as described above is particularly suitable for use in the outer sidewall of a tyre.

The abovementioned features of the present invention, and also others, will be better understood on reading the following description of several exemplary embodiments of the invention, which are given by way of nonlimiting illustration.

### EXAMPLES

### Measurements and Tests Used

### Size Exclusion Chromatography

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards via a “Moore” calibration.

### Procedure

The number-average molar mass (Mn), the weight-average molar mass (Mw) of the constituents which can be used in the compositions in accordance with the invention are determined in a known manner, by conventional size exclusion chromatography (SEC) with RI detection and PS (polystyrene) calibration. The PS standards are from the “PSS-kitr1l” kit from PSS-Polymers.

In order to determine the average molar masses, use is made of the 1.5 g/l solution of the sample previously prepared and filtered on a 0.45 μm PTFE filter, which is injected into the chromatographic system. The equipment used is a Waters Alliance e2695 chromatographic line with a Waters RI 410 detector. The elution solvent is tetrahydrofuran, the flow rate is 1 ml·min⁻¹, the temperature of the system is 35° C. and the analytical time is 50 min. Four Agilent columns are used (2 PLGEL 5 μm Mixed-D and 2 PLGEL 3 μm Mixed-E). The volume of the sample solution injected is 100 μl.

The software for processing the chromatographic data is the Waters Empower system.

### Differential Calorimetry

The glass transition temperatures (Tg) of the elastomers are determined using a differential scanning calorimeter according to standard ASTM D3418 (1999).

### Criterion of Stiffness at Low Strain:

The stiffness is represented by the value of the modulus G*, return cycle at 10%, during the strain sweep measurements at 60° C. from 0.01% to 100% peak-to-peak.

The dynamic properties G* are measured on a viscosity analyser (Metravib VA4000) according to standard ASTM D 5992-96. The response of a sample of vulcanized composition (cylindrical test specimen with a thickness of 2 mm and a cross section of 79 mm²), subjected to a simple alternating sinusoidal shear stress, at a frequency of 10 Hz, under standard temperature conditions (60° C.) according to standard ASTM D 1349-99, is recorded. A strain amplitude sweep is carried out from 0.1% to 100% peak-to-peak (outward cycle) and then from 100% to 0.1% peak-to-peak (return cycle). The result used is the modulus of stiffness G*, return cycle at 10% strain. The higher this number, the greater the stiffness at low strain.

### Criterion of Stiffness at High Strain:

The stiffness at high strain is represented by the elongation and breaking stress values measured during tensile tests.

### Tensile Tests

These tensile tests make it possible to determine the elasticity stresses and the properties at break. Unless otherwise indicated, they are carried out in accordance with French Standard NF ISO37 of December 2005. The tensile strengths (in MPa) and the elongations at break (in %) are measured under standard temperature (23° C.±2° C.) and humidity (50%±10% relative humidity) conditions. Processing the tensile test recordings also makes it possible to plot the curve of modulus as a function of the elongation.

### Tests

### Production of Esters.

The biobased plasticizers based on erucic acid ester were obtained according to the following protocols:

A—Erucic Acid Ester with Isostearyl Alcohol (Oil No. 1)

### Reaction Scheme (Oil No. 1)

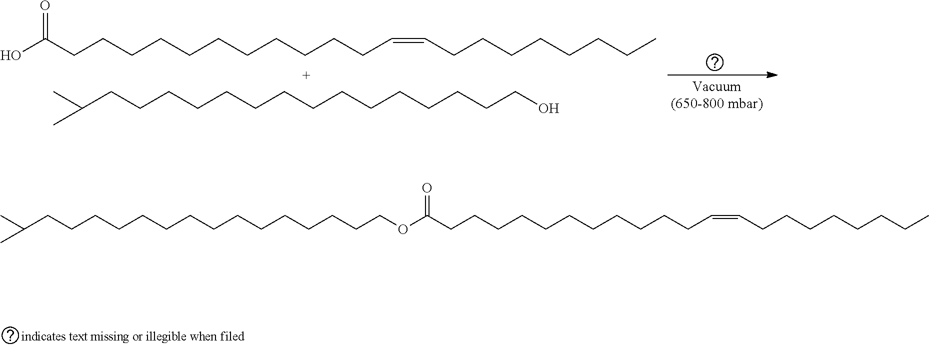

### Protocol:

The reaction was carried out in two steps; the first consisted of an esterification between erucic acid and a large excess of isostearyl alcohol (3 molar eq.). The second step consisted in distilling the excess alcohol that had not reacted.

### Step 1: Esterification

### Procedure:

Stirred batch reactor
Conditions: 160° C. max/light vacuum
Analytical monitoring: Acid value according to the standard NF EN ISO 660 and GC (composition %)

### Step 2: Short-Path Molecular Distillation

### Conditions:

Trap temp.:−22° C.
Addition pump speed: 230 ml/h
Jacket temp.: 190° C.
Vacuum: 2.8×10-1 mbar
Analytical monitoring: GC (composition %)

Two molecular distillation passes were necessary to reach a residual alcohol percentage of less than 2%.

### B—Diester of Erucic Acid and a C₃₆ Diol Dimer

### Reaction Scheme (Oil No. 2)

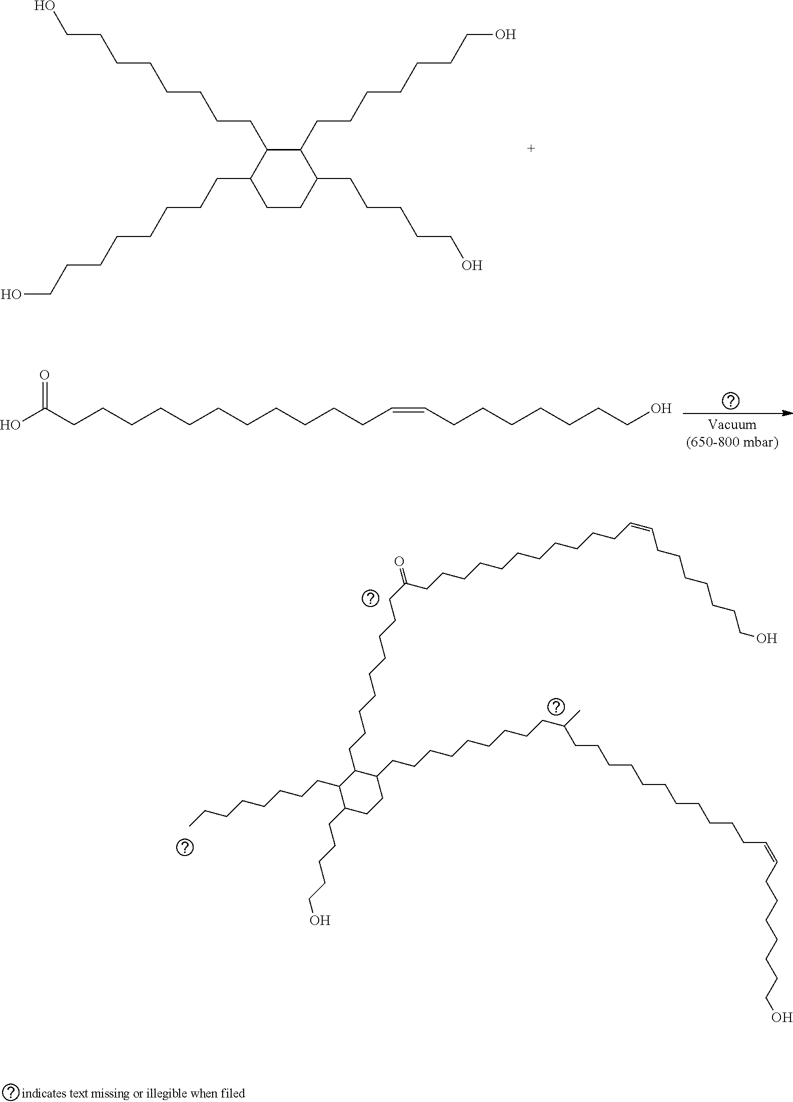 [SMILES: OCCCCCCCCC1CCC(CCCCCO)C(CCCCCCCO)C1CCCCCCCCO ; O=C(O)CCCCCCCCCCC/C=C\CCCCCCCO ; CCCCCCCCC1C(CCCCCO)CCC(CCCCCCCCCC(C)CCCCCCCCCCC/C=C\CCCCCCCO)C1CCCCCCCCCC(=O)CCCCCCCCCCC/C=C\CCCCCCCO]

### Protocol:

The reaction was carried out in two steps; the first consisted of an esterification between erucic acid (3 molar eq.) and a branched diol, Pripol 2033. The second step consisted in distilling the excess erucic acid that had not reacted.

### Step 1: Esterification

### Procedure:

Stirred batch reactor
Conditions: 180° C. max/light vacuum
Analytical monitoring: SEC

### Step 2: Short-Path Molecular Distillation

### Conditions:

Trap temp.:−22° C.
Addition pump speed: 230 ml/h
Jacket temp.: 210° C.
Vacuum: 1.5×10⁻¹ mbar
Analytical monitoring: SEC (composition %)

Two molecular distillation passes were necessary to reach a residual erucic acid percentage of less than 1%.

The table below gives the weight-average molar mass (Mw) and glass transition temperature (Tg) characteristics of the two biobased plasticizers in accordance with the invention compared to the non-biobased oil (MES oil).

TABLE 1

| Component | Nature | Tg (° C.) | Mw (g. mol) |
|---|---|---|---|
| MES oil (8) | Paraffinic | −60 | 711 |
| Oil no. 1 (9) | Erucic acid monoester | −51 | 1180 |
| Oil no. 2 (10) | Erucic acid diester | −63 | 2160 |

### Compositions

The “reference” composition T is presented in the table below and it comprises a MES oil that is of fossil origin.

It should be noted that compositions C1 and C2, in accordance with the present invention, are formulated so as to be at the same volume dilution in oil (% v) as the control composition T.

The compositions are as follows (in phr).

TABLE 2

| Components | T | C1 | C2 |
|---|---|---|---|
| NR (1) | 35 | 35 | 35 |
| BR (2) | 65 | 65 | 65 |
| Black (3) | 48 | 48 | 48 |
| 6PPD (4) | 1.5 | 1.5 | 1.5 |
| IPPD (5) | 1.5 | 1.5 | 1.5 |
| TMQ (6) | 1 | 1 | 1 |
| Wax (7) | 1 | 1 | 1 |
| MES oil (8) | 18 | | |
| Oil no. 1 (9) | | 18 | |
| Oil no. 2 (10) | | | 18 |
| ZnO (11) | 2.4 | 2.4 | 2.4 |
| Stearic acid (12) | 1 | 1 | 1 |
| Acc (13) | 1.4 | 1.4 | 1.4 |
| Sulfur | 1.4 | 1.4 | 1.4 |

(1) Natural rubber with a Tg equal to −70° C.
(2) Polybutadiene with a Tg equal to −108° C.
(3) ASTM N550 black from Cabot
(4) Santoflex 6PPD from Solutia
(5) Santoflex IPPD from Solutia
(6) Antioxidant, DQ from Akrochem
(7) Anti-ozone wax, Varazon 6500 from Sasol
(8) MES oil, Flexion 683 from Exxon-Mobil
(9) Oil no. 1: erucic acid monoester with Mw = 591 g/mol and Tg = −51° C.
(10) Oil no. 2: erucic acid diester with Mw = 1176 g/mol and Tg = −63° C.
(11) Zinc oxide, industrial grade-Umicore
(12) Stearin, Pristerene 4931, from Uniqema
(13) Cyclohexyl-benzothiazole sulfenamide CBS from Akrochem

### Preparation of the Compositions

The rubber compositions, the details of the formulation of which are given in Table 2, were prepared in the following manner:

The elastomer matrix is introduced into an internal mixer (final degree of filling: approximately 70% by volume and blade speed 50 rpm), the initial vessel temperature of which is approximately 90° C. When the temperature reaches 100° C., the carbon black and the plasticizer are introduced. Thermomechanical working (non-productive phase) is then performed in one step, which lasts in total approximately 3 to 4 min, until a maximum “dropping” temperature of 160° C. is reached. The mixture thus obtained is recovered and cooled, and sulfur and the vulcanization accelerators are then incorporated on a mixer (homofinisher) at 30° C., the whole being mixed (productive phase) for an appropriate time (for example approximately ten minutes).

The compositions thus obtained are subsequently calendered, either in the form of slabs (thickness of 2 to 3 mm) or of thin sheets of rubber and are vulcanized at their optimum at a temperature of 160° C., for the measurements of their physical and mechanical properties, which are set out in Table 3.

### Results

TABLE 3

| Properties | Descriptors | T | C1 | C2 |
|---|---|---|---|---|
| Dynamic: strain | G*10% return at 60° C. (MPa) | 1.2 | 1.2 | 1.3 |
| Mechanical: | Elongation at break (%) | 100 | 110 | 105 |
| uniaxial tension | Breaking stress (MPa) | 100 | 102 | 102 |

The criterion of stiffness G*10% strain remains unchanged. The mechanical properties of the rubber compositions comprising a biobased plasticizer according to the invention are maintained at low strain compared to the mechanical properties of a standard rubber composition comprising a conventional plasticizer of fossil origin.

Moreover, and surprisingly, the two compositions in accordance with the invention comprising a biobased plasticizer makes it possible to improve the tensile strength by improving the stiffness at high strain, since the elongation at break and breaking stress are significantly improved compared to the standard rubber composition comprising a conventional plasticizer of fossil origin.

1.-15. (canceled)

16. A rubber composition based on at least:
100 phr of an elastomer matrix comprising an isoprene elastomer and a butadiene elastomer;
20 to 120 phr of a reinforcing filler comprising carbon black as predominant filler;
5 to 120 phr of a plasticizing system comprising an ester of a fatty acid and an alcohol selected from fatty alcohols and diol dimers, with a weight-average molar mass Mw of less than 5000 g/mol determined by size exclusion chromatography; and
a crosslinking system.

17. The rubber composition according to claim 16, wherein a content of isoprene elastomer is within a range extending from 10 to 60 phr.

18. The rubber composition according to claim 16, wherein the isoprene elastomer predominantly comprises natural rubber.

19. The rubber composition according to claim 16, wherein a content of butadiene elastomer is within a range extending from 40 to 90 phr.

20. The rubber composition according to claim 16, wherein the butadiene elastomer is a polybutadiene.

21. The rubber composition according to claim 16, wherein the reinforcing filler consists essentially of carbon black.

22. The rubber composition according to claim 16, wherein the carbon black is present at a content within a range extending from 20 phr to 100 phr.

23. The rubber composition according to claim 16, wherein a content of the at least one ester of a fatty acid and an alcohol selected from fatty alcohols and diol dimers is within a range extending from 5 to 50 phr.

24. The rubber composition according to claim 16, wherein the plasticizing system comprises from 10% to 100% by weight of at least one ester of a fatty acid and an alcohol selected from fatty alcohols and diol dimers relative to a total weight of the plasticizing system.

25. The rubber composition according to claim 16, wherein the plasticizing system consists essentially of at least one ester of a fatty acid and an alcohol selected from fatty alcohols and diol dimers.

26. The rubber composition according to claim 16, wherein the fatty acid is a C₈ to C₃₄ fatty acid.

27. The rubber composition according to claim 16, wherein the alcohol is a linear or branched, saturated or unsaturated C₁₂ to C₂₂ fatty alcohol.

28. The rubber composition according to claim 16, wherein the alcohol is a saturated or unsaturated, alicyclic diol dimer.

29. The rubber composition according to claim 16, wherein the at least one ester of a fatty acid and an alcohol is the ester of erucic acid and isostearyl alcohol or an ester of erucic acid and an alicyclic C₃₆ diol dimer.

30. A tire having an outer sidewall, the outer sidewall comprising at least one rubber composition according to claim 16.
